(19) United States
(12) Patent Application Publication
(10) Pub. No.: US 2010/0318725 A1
(43) Pub. Date: Dec. 16, 2010

(54) Multi-Processor System Having Function of Preventing Data Loss During Power-Off in Memory Link Architecture

(76) Inventor: Jin-Hyoung Kwon, Seongnam-si (KR)

Correspondence Address: F. CHAU & ASSOCIATES, LLC, 130 WOODBURY ROAD, WOODBURY, NY, 11797, US

(21) Appl. No.: 12/689,854

(22) Filed: Jan. 19, 2010

(30) Foreign Application Priority Data
Jun. 12, 2009 (KR) 10-2009-0052312

(51) Int. Cl. G06F 12/02; G06F 1/32

(52) U.S. Cl. 711/103; 711/149; 711/115; 711/E12.002; 713/320

(57) ABSTRACT

Exemplary embodiments relate to a multi-processor system including: a first processor for writing a power-off check command to a first mail box, reading a power-off wait message or a power-off allowance message written to a second mail box, and waiting or turning off the multi-processor system, in a power-off operation mode; a second processor for indicating whether data is completely stored during a current processing operation in response to the power-off check command in the first mail box and writing the power-off wait message or the power-off allowance message to the second mail box according to the indication result; and a multi-port semiconductor memory device having an internal register that includes the first and second mail boxes and dedicated and shared memory areas for data processing. The first and second mail boxes serve as latch storage units, and the dedicated and shared memory areas are accessed by the first and second processors.

### CROSS-REFERENCE TO RELATED APPLICATIONS

This patent application claims priority from Korean Patent Application 10-2009-0052312, filed on Jun. 12, 2009, in the Korean Intellectual Property Office, the contents of which are herein incorporated by reference in their entirety.

### BACKGROUND

1. Field of the Invention

Exemplary embodiments of the present invention are directed to a multi-processor system, and more particularly, to a multi-processor system having a memory link architecture.

2. Description of the Related Art

In recent years, multi-processor systems that include a plurality of processors in one system have been used for many types of portable electronic apparatuses, such as a portable multi-media player (PMP), a mobile phone, a smart phone, a GPS navigation apparatus, a digital camera, a digital video camera, and a personal digital assistant (PDA), to improve functionality, increase operating speed, and smoothly perform operations. For example, the mobile phone may have music, game, camera, payment, and moving picture player functions in addition to a basic call function, according to the user's demand for convergence. In this case, both a communication processor for communication modulation and demodulation and a media processor for performing applications other than the communication function should be provided on a printed circuit board of the mobile phone.

In a multi-processor system, the operation or function of a semiconductor memory used to store processing data may be changed in various ways. For example, the simultaneous input or output of data through a plurality of access ports may be needed. Multi-port semiconductor memory devices have been introduced that can significantly increase a data process speed between the communication processor and the media processor in the mobile device. In general, when two processors are provided, two memories are required. However, since there are solutions that can route data between the processors using a single chip, it is possible to remove the requirement of two memories. In addition, when a dual port approach is used, the time required for data transmission between the processors can be significantly reduced.

A multi-processor system using a multi-port semiconductor memory device can form a memory link architecture in which a multi-port semiconductor memory device and a flash memory are linked to an arbitrary processor.

In the memory link architecture, when a first processor instantaneously turns off the multi-processor system while a second processor is storing data in the flash memory, not all data to be stored is actually stored in the flash memory, which results in data loss.

### SUMMARY OF THE INVENTION

Exemplary embodiments provide a multi-processor system capable of preventing data loss during power-off in a memory link architecture.

Exemplary embodiments also provide a multi-processor system capable of handling a sudden power-off operation by allowing a plurality of processors to transmit a power-off message therebetween through a multi-port semiconductor memory device.

Exemplary embodiments also provide a multi-processor system capable of indicating whether data is stored in a flash memory and performing a power-off operation according to the indicator result when the power-off operation is performed in a structure in which any one of a plurality of processors connected to a multi-port semiconductor memory device is connected to the flash memory.

Exemplary embodiments also provide a method of preventing data loss when a host processor is turned off in a flash-less structure in which any one of a plurality of processors connected to a multi-port semiconductor memory device is not directly connected to a flash memory.

Exemplary embodiments also provide a small mobile device having a low system construction cost and capable of preventing data loss during a power-off operation.

According to exemplary embodiments, a multi-processor system includes: a first processor for writing a power-off check command to a first mail box, reading a power-off wait message or a power-off allowance message written to a second mail box, and waiting or turning off the multi-processor system, in a power-off operation mode; a second processor for indicating whether data is completely stored during a current processing operation in response to the power-off check command in the first mail box and writing the power-off wait message or the power-off allowance message to the second mail box according to the indicating result; and a multi-port semiconductor memory device having an internal register including the first and second mail boxes and dedicated and shared memory areas for data processing that are accessed by the first and second processors.

A multi-processor system according to an embodiment of the invention may further include a non-volatile semiconductor memory device connected to the second processor for storing data of the first processor through the multi-port semiconductor memory device.

The non-volatile semiconductor memory device, the multi-port semiconductor memory device, and the second processor may form a memory link architecture.

The current processing operation may be an operation of storing data of the shared memory area in the non-volatile semiconductor memory device or an operation of storing meta data of the dedicated memory area in the non-volatile semiconductor memory device.

According to exemplary embodiments, a multi-processor system includes: a multi-port semiconductor memory device including dedicated memory areas that are exclusively accessed by corresponding processors of a plurality of processors, a shared memory area that is shared by all processors of the plurality of processors, and an internal register that includes first and second mail boxes for communication between the processors and a semaphore area that stores authority information about the use of the shared memory area; a second processor for indicating whether data is completely stored during a current processing operation in response to a power-off check command in the first mail box and writing a power-off wait message or a power-off allowance message to the second mail box according to the indicating result; and a non-volatile semiconductor memory device connected to the second processor for storing data of the second processor.

The non-volatile semiconductor memory device may be a flash memory device.

A multi-processor system according to an embodiment of the invention may further include a first processor for writing the power-off check command to the first mail box, reading the power-off wait message or power-off allowance message written to the second mail box by the second processor, turning off the multi-processor system in response to the power-off allowance message, and waiting for power-off allowance message in response to the power-off wait message, in a power-off operation mode. The non-volatile semiconductor memory device also stores data of the first processor through the multi-port semiconductor memory device.

According to exemplary embodiments, there is provided a method of preventing data loss during power-off in a multi-processor system including a plurality of processors that accesses a shared memory area of a multi-port semiconductor memory device. The method includes: transmitting, by a transmitter-side processor, a power-off check command to a first mail box of the multi-port semiconductor memory device in a power-off operation mode; transmitting, by a receiver-side processor, a power-off wait message to a second mail box of the multi-port semiconductor memory device when a current processing operation is a data storage operation; waiting, by the transmitter-side processor, to turn off the multi-processor system in response to receiving the power-off wait message; and turning off, by the transmitter-side processor, the multi-processor system in response to receiving a power-off allowance message through the second mail box.

A multi-processor system according to an embodiment of the invention may be any one of a mobile phone, a portable multi-media player (PMP), a play station portable (PSP), a personal digital assistant (PDA), and a mobile phone for a vehicle. The non-volatile memory may be an electrically erasable programmable read-only memory (EEPROM), a flash memory, or a PRAM (phase-change random access memory).

According to the above-mentioned exemplary embodiments of the invention, when data is stored by communication through a memory during power-off in a multi-processor system, a power-off operation is performed after a data storage operation is completed. Therefore, since power is not instantaneously turned off during the data storage operation, it is possible to prevent data loss. As such, in a memory link architecture according to an embodiment of the invention, data loss due to power-off is prevented. As a result, a multi-processor system according to an embodiment of the invention is stabilized and operating performance is improved.

### BRIEF DESCRIPTION OF THE DRAWINGS

FIG. 1 is a block diagram illustrating a multi-processor system according to an exemplary embodiment of the invention.

FIG. 2 is a diagram illustrating the detailed structure of a memory link architecture including a multi-port semiconductor memory device shown in FIG. 1, according to an embodiment of the invention.

FIG. 3 is a diagram illustrating the allocation of addresses to memory banks and an internal register of the multi-port semiconductor memory device shown in FIG. 2 and an access thereto, according to an embodiment of the invention.

FIG. 4 is a diagram illustrating an example of the flow of the operation of a multi-processor system according to an embodiment of the invention shown in FIG. 2 in the power-off operation mode.

### DETAILED DESCRIPTION OF EXEMPLARY EMBODIMENTS

Exemplary embodiments will now be described more fully with reference to the accompanying drawings. In the drawings, the thicknesses of layers and regions may be exaggerated for clarity. Exemplary embodiments may, however, may be embodied in many alternate forms and should not be construed as limited to only the embodiments set forth herein. Like numbers refer to like elements throughout the description of the figures.

It will be understood that when an element is referred to as being “connected” or “coupled” to another element, it can be directly connected or coupled to the other element or intervening elements may be present.

Hereinafter, a multi-processor system that can prevent data loss during power-off in a memory link architecture according to exemplary embodiments of the invention will be described with reference to the accompanying drawings.

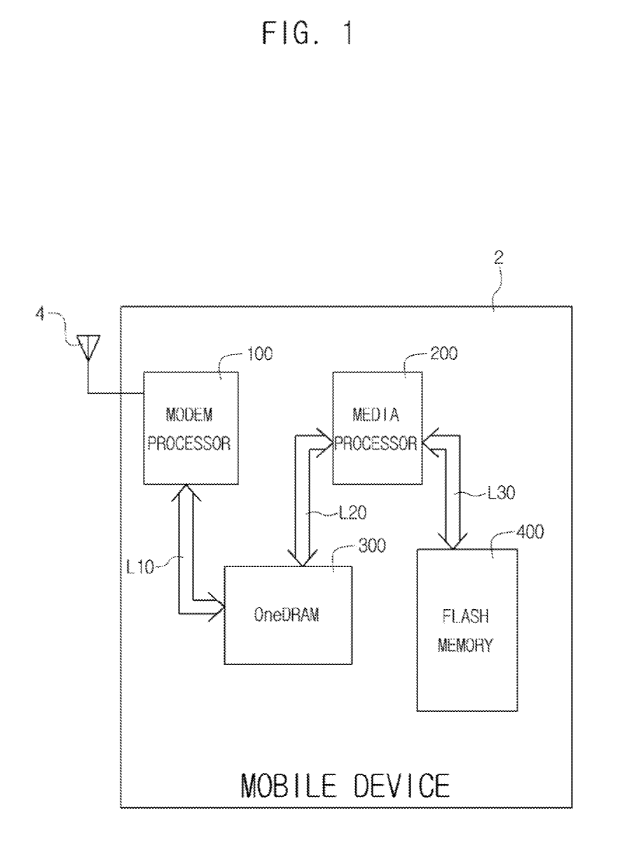

FIG. 1 is a block diagram illustrating a multi-processor system according to an exemplary embodiment of the invention. Referring to FIG. 1, a mobile device 2, which is an example of a multi-processor system, includes a first processor 100 serving as a modem processor, a second processor 200 serving as a media processor, a fusion memory chip (FMC) 300 serving as a multi-port semiconductor memory device, and a flash memory 400. A fusion memory chip is a combination of types of memory, such as DRAM, SRAM, and flash memory, and non-memory such as logic and software, on a single chip. FMC 300 is a multi-port chip that can eliminate the need for two memory buffers because it can route data between the processors via a single chip.

In FIG. 1, the first processor 100 is connected to a communication antenna 4 and may basically have the function of a modem processor that performs a predetermined task, for example, modulating and demodulating communication signals. The second processor 200, which is a media processor, may process communication data or perform user convenience functions, such as entertainments or games. However, the functions of the processors may be reversed or additional functions may be added to the processors.

The first processor 100 is connected to the FMC 300 through a system bus L10, and the second processor 200 is connected to the FMC 300 through a system bus L20. Therefore, the first and second processors 100 and 200 share the FMC 300. It is not necessary to use two DRAMs. As a result, the size and cost of constructing a system are reduced.

The flash memory 400 is connected to the second processor 200 through a system bus L30, and thus the first processor 100 can indirectly access the flash memory 400 through the FMC 300 and the second processor 200. On the other hand, the second processor 200 can directly access the flash memory 400.

The flash memory 400 may be a NOR flash memory in which a cell array has a NOR structure or a NAND flash memory in which a cell array has a NAND structure. Both the NOR flash memory and the NAND flash memory are non-volatile memory that include a memory cell array in which a MOS transistor has a floating gate. The NOR or NAND flash memory is provided to store data that should not be removed when power is turned off, such as boot code of a mobile device, programs, communication data, or storage data. Therefore, since one flash memory 400 is provided for two processors in the system, the size and cost of constructing the system are reduced.

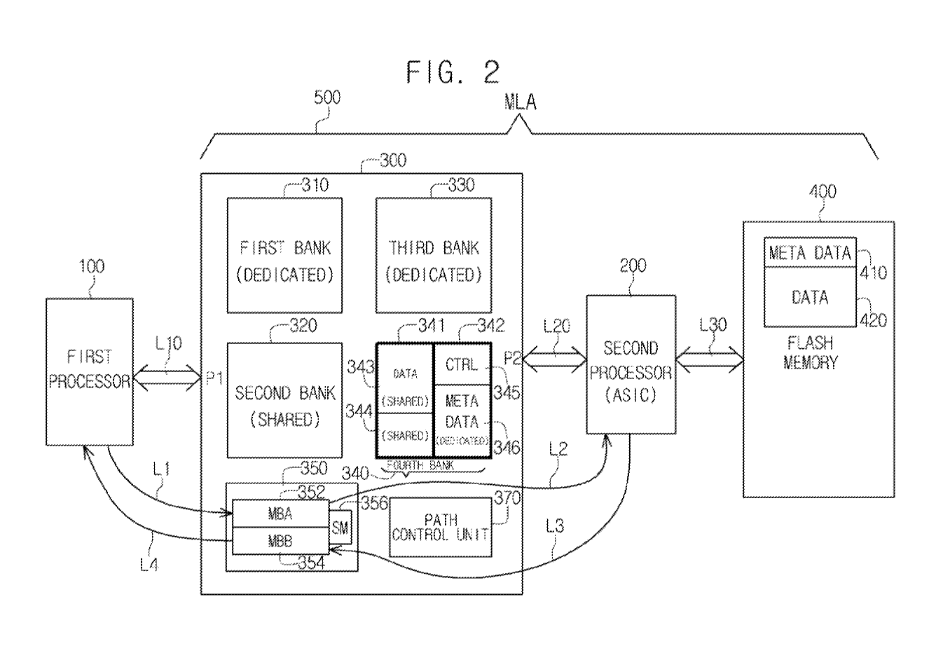

The FMC 300 serves as a main memory for processing the data of the first and second processors 100 and 200. As shown in FIG. 2, the FMC 300 includes a plurality of ports P1 and P2 and a plurality of memory banks 310, 320, 330, and 340 to allow a multi-port access. An FMC such as FMC 300 that includes a plurality of ports and a plurality of memory banks differs from a general DRAM having a single port.

FIG. 2 is a block diagram illustrating the detailed structure of a memory link architecture including the multi-port semiconductor memory device shown in FIG. 1.

Referring to FIG. 2, a first port P1 of the FMC 300 is connected to the first processor 100 through the system bus L10, and a second port P2 thereof is connected to the second processor 200 through the system bus L20. That is, the first and second processors 100 and 200 access the memory banks of the FMC 300 through two different access paths.

As shown in FIG. 2, when the FMC 300 has a memory cell array including four memory areas, the first bank 310, which is a memory area, may be exclusively accessed by the first processor 100, and the third bank 330 and a second-half bank 342 of the fourth bank 340 may be exclusively accessed by the second processor 200. The second bank 320 and a first-half bank 341 of the fourth bank 340 may be accessed by both the first and second processors 100 and 200 through different ports. Thus, in the memory cell array, the second bank 320 and the first-half banks 341 of the fourth bank 340 are allocated as shared memory areas, and the other banks are allocated as dedicated memory areas that are accessed by the corresponding processors.

When the first processor 100 accesses the second bank 320 through the first port P1, a path control unit 370 of the FMC 300 connects the second bank 320 to the system bus L10. While the first processor 100 is accessing the second bank 320, the second processor 200 may access the third bank 330 or the second-half bank 342 of the fourth bank 340, which is a dedicated memory, through the second port P2. After the first processor 100 is finished accessing the second bank 320, the second processor 200 may access the second bank 320, which is a shared memory area. The second-half bank 342 that is exclusively accessed by the second processor 200 may be divided into a control data storage area (CTRL) 345 and a meta data storage area 346. The first-half bank 341, which is a shared memory area, may be divided into a cache flush data storage area 343 and a general shared data storage area 344.

Each of the first to fourth banks 310, 320, 330, and 340 may include DRAM cells each having an access transistor and a storage capacitor. The DRAM cells perform a refresh operation to keep storage charges in the cells. The first to fourth banks 310, 320, 330, and 340 may be banks of a DRAM, and each bank may include a memory storage capacity of, for example, 16 Mb (megabits), 32 Mb, 64 Mb, 128 Mb, 256 Mb, 512 Mb, or 1024 Mb.

An internal register 350 provides information about the path control of the path control unit 370, performs interfacing between the first and second processors 100 and 200, and is a data storage area that is provided separately from the memory cell array area. That is, the internal register 350 is accessed by both the first and second processors 100 and 200 and may be composed of a latch circuit such as a flip-flop. The internal register 350 is composed of a memory cell of a latch type different from that of the memory cell of the DRAM, for example, an SRAM cell. Therefore, the internal register 350 does not require a refresh operation.

The internal register 350 includes a semaphore area (SM) 356, a first mail box (MBA) 352, and a second mail box (MBB) 354.

In FIG. 2, in the power-off operation mode, the first processor 100 writes a power-off check command to the first mail box 352, reads a power-off wait message or a power-off allowance message written to the second mail box 354, and waits for or instantaneously performs an operation of turning off the multi-processor system. That is, the first processor 100 serves as a host processor of the multi-processor system.

The second processor 200 checks whether data is completely stored in the current processing operation in response to the power-off check command in the first mail box 352, and writes the power-off wait message or the power-off allowance message to the second mail box 354 on the basis of the check result.

The FMC 300 serving as a multi-port semiconductor memory device has the first and second mail boxes 352 and 354 as latch storage units and includes the dedicated and shared memory areas 310, 320, 330, and 340 for data processing.

In FIG. 2, the FMC 300, the second processor 200, which may be an application-specific integrated circuit (ASIC), and the flash memory 400 including a meta data storage area 410 and a general data storage area 420 form a memory link architecture (MLA) 500.

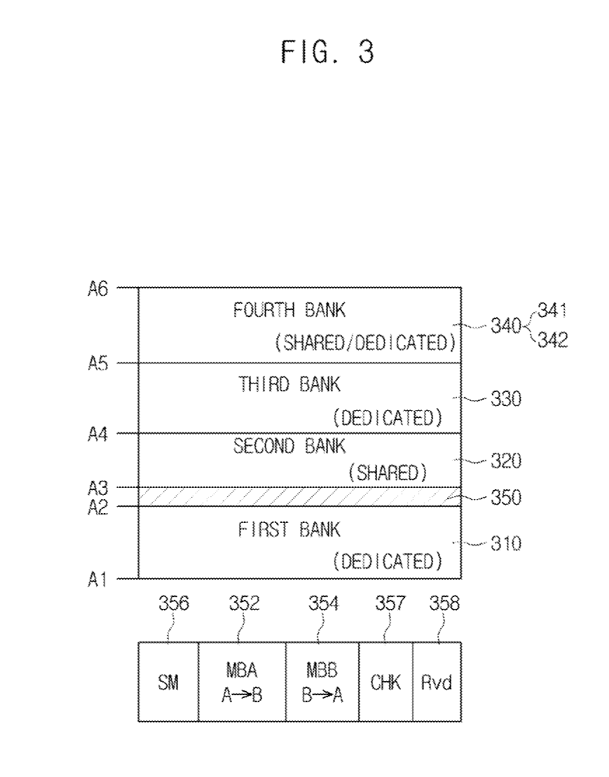

FIG. 3 is a diagram illustrating the allocation of addresses to the memory banks and the internal register of the multi-port semiconductor memory device shown in FIG. 2 and an access thereto.

The banks 310, 320, 330, and 340 shown in FIG. 3 are the same as the first to fourth banks 310, 320, 330, and 340 shown in FIG. 2. A specific area of the second bank 320, which is a shared memory area, is set as a disable area 350. That is, specific row addresses 0x7FFFFFFFh to 0x8FFFFFFFh (2 KB=size of one row) that enable an arbitrary row of the shared memory area 320 are allocated to access the internal register 350. When the specific row addresses 0x7FFFFFFFh to 0x8FFFFFFFh are allocated between an address A2 and an address A3, a corresponding specific word line area is disabled, and the internal register 350 is enabled. That is, the semaphore area 356 and the mail boxes 352 and 354 are accessed by a direct address mapping method. In addition, inside of the system, the internal register 350 provided outside the memory cell array is mapped by analyzing instructions which access the disabled address. Therefore, a memory controller of a chipset driven by the processors generates a command to the area 350 shown in FIG. 3 by the same method as that for the cells of another memory.

In FIG. 3, access authority information on the shared memory area is stored in the semaphore area 356. Messages, such as an authority request, an address, a data size, transmission data indicating the address of the shared memory storing data, and instructions, transmitted between the first and second processors 100 and 200 are written to the first and second mail boxes 352 and 354. That is, messages transmitted from the first processor 100 to the second processor 200 are written to the first mail box 352, and messages transmitted from the second processor 200 to the first processor 100 are written to the second mail box 354. In the power-off operation mode according to an embodiment of the invention, a power-off check command POC CMD is written to the first mail box 352 and a power-off wait message or a power-off allowance message is written to the second mail box 354.

In FIG. 3, the semaphore area 356 may be allocated with at least one bit and each of the first and second mail boxes 352 and 354 may be allocated with 16 bits. In addition, a check bit area (CHK) 357 may be allocated with 4 bits, and a reserved area (Rvd) 358, which is a spare area, may be allocated with 2 bits.

When the interface between the first and second processors 100 and 200 is implemented by the FMC 300, one of the first and second processors 100 and 200 may write the messages to be transmitted to the other processor to the first and second mail boxes 352 and 354. The receiver-side processor receiving the written message recognizes the message transmitted from the transmitter-side processor and performs an operation corresponding to the message.

For example, when the second processor 200 shown in FIG. 2 gives the first processor 100 access authority to the second bank 320, which is a shared memory area of the FMC 300, the second processor 200 changes the flag data of the semaphore area 356 in the internal register 350 and writes a message to the second mail box 354 indicating that access authority is transferred. Then, the access authority to the second bank 320 is given to the first processor 100. The first processor 100 reading the message in the second mail box 354 reads a message for the transfer of the access authority and checks whether the flag data of the semaphore area 356 has been changed. After checking that the flag data has been changed, the first processor 100 writes a response message indicating the reception of the access authority to the first mail box 352. Then, the first processor 100 exclusively uses the access authority to the shared memory area 320 until it receives a request to transfer the access authority from the second processor 200 or its task is completed.

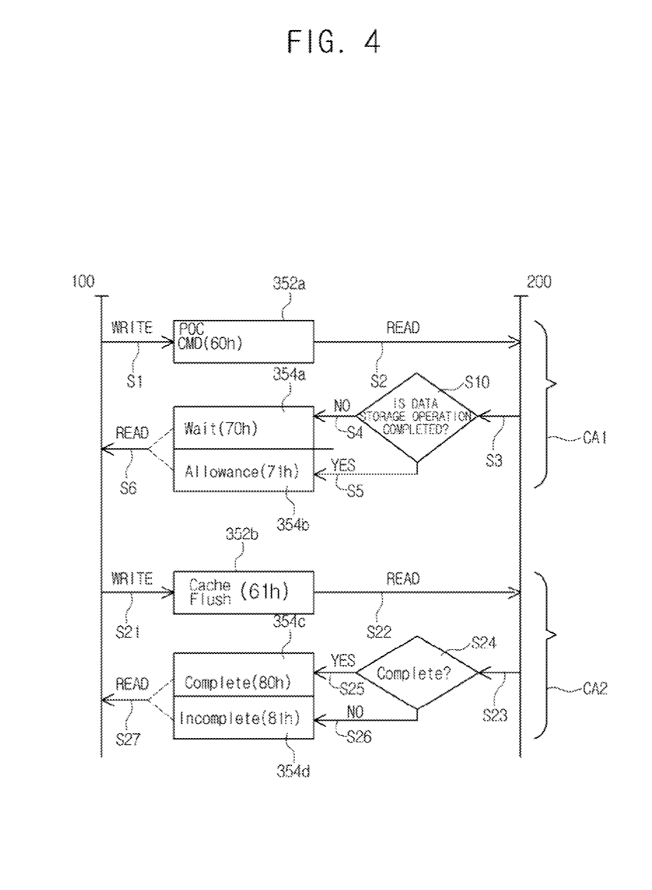

Next, an example in which the first processor 100 performs the power-off mode without any data loss while the second processor 200 performs a data storage operation will be described with reference to FIG. 4.

FIG. 4 is a diagram illustrating the operation flow of a multi-processor system of FIG. 2 in the power-off operation mode. A first case CA1 shows the operation flow in the power-off operation mode and a second case CA2 shows the operation flow of a cache flush mode that is performed separately from the power-off operation mode. It will be understood that the second case CA2 does not relate to the power-off operation mode, but power may be turned off after the second case CA2 operation is completed.

In the power-off operation mode of the first case CA1, the first processor 100 writes a power-off check command to the first mail box 352 through a line L1. The write step corresponds to Step S1 of FIG. 4. As shown in a mail box 352a of FIG. 4, the written message may be ‘POC CMD’, an exemplary, non-limiting value of which is a hexadecimal number 60h. The second processor 200 reads the written power-off check command through a line L2 in Step S2 of FIG. 4. The second processor 200 recognizes that the first processor 100 has transmitted the power-off check command in Step S3 and indicates whether a data storage operation is completed in Step S10. The data storage operation involves having the second processor 200 access the second port P2 and storing the data of the FMC 300 in the flash memory 400. For example, when power is turned off while the second processor 200 is transferring data from the first-half bank 341 to the flash memory 400 or transferring control data or meta data from the second-half bank 342 to the flash memory 400, data loss occurs. Therefore, power is turned off after the first processor 100 receives the power-off allowance message in a second mail box 354b in response to transmitting the power-off check command to the first mail box 352. In FIG. 4, Step S4 occurs when data is not completely stored during the current processing operation, and Step S5 occurs when data is completely stored. When data is not completely stored, the second processor 200 writes a turn-off wait message to the second mail box 354 through a line L3. In this case, the written message ‘Wait’ may be a hexadecimal number 70h, as shown in a mail box 354a of FIG. 4. On the other hand, when data is completely stored, the second processor 200 writes a turn-off allowance message to the second mail box 354 through the line L3. In this case, the written message ‘Allowance’ may be a hexadecimal number 71h, as shown in the mail box 354b of FIG. 4. In Step S6, the first processor 100 reads the message written to the second mail box 354 through a line L4.

Therefore, after reading the power-off wait message, the first processor 100 waits for the power-off allowance message to be received. After receiving the power-off allowance message, the first processor 100 substantially instantaneously turns off the multi-processor system.

When power is turned off after performing the first case operation, data loss due to power-off is prevented in the memory link architecture. As a result, a multi-processor system according to an embodiment of the invention is stabilized and operating performance is improved.

Next, the second case CA2 for cache flush will be described. A cache flush operation is an example of the data storage of Step S10, above. In the normal operation mode of the second case CA2, the first processor 100 writes a cache flush command to the first mail box 352 through the line L1. The write step corresponds to Step S21 of FIG. 4. As shown in the mail box 352b of FIG. 4, the written message ‘Cache Flush’ may be a hexadecimal number 61h. The second processor 200 reads the written cache flush command through the line L2 in Step S22 of FIG. 4. The second processor 200 recognizes that the first processor 100 has transmitted the cache flush command in Step S23 and indicates whether the cache flush operation has completed in Step S24. The cache flush operation involves having the second processor 200 access the second port P2 and transferring cache data from the memory area 343 of the FMC 300 to the flash memory 400. In FIG. 4, Step S25 occurs when the cache flush operation has completed and Step S26 occurs when the cache flush operation has not completed. When the cache flush operation has completed, the second processor 200 writes a complete message to the second mail box 354 through the line L3. In this case, as shown in a mail box 354c of FIG. 4, the written message ‘Complete’ may be a hexadecimal number 80h. On the other hand, when the cache flush operation has not completed, the second processor 200 writes an incomplete message to the second mail box 354 through the line L3. In this case, as shown in a mail box 354d of FIG. 4, the written message ‘Incomplete’ may be a hexadecimal number 81h. In Step S27, the first processor 100 reads the message written to the second mail box 354 through the line L4.

Therefore, after reading the incomplete message, the first processor 100 waits for the complete message to be received. After receiving the complete message, the first processor 100 substantially instantaneously turns off the multi-processor system or performs other operations.

When power is turned off after performing the second case operation, data loss due to power-off is prevented in the memory link architecture.

In FIG. 2, the path control unit 370 connects the shared memory areas to the selected ports, and selectively controls an input/output sense amplifier, a driver, and a multiplexer on a data path for shared access.

As can be seen from the above, in a multi-processor system according to exemplary embodiments of the invention, power is turned off after data being transferred through a memory is completely stored. Therefore, power is not turned off during a data storage operation. As a result, data loss is prevented. As such, in a memory link architecture according to an embodiment of the invention, data loss due to power-off is prevented. Therefore, a multi-processor system according to an embodiment of the invention is stabilized and the operating performance is improved.

In a multi-processor system according to the above-described exemplary embodiment of the invention, three or more processors may be provided. The processors of the multi-processor system may include a microprocessor, a CPU, a digital signal processor, a microcontroller, a reduced command set computer, a complex command set computer, and equivalents thereof. However, the number of processors in the system is not particularly limited. In addition, the scope of an embodiment of the invention is not limited to a specific combination of the processors having the same structure or different structures.

While exemplary embodiments of the invention have been shown and described with reference to the accompanying drawings, it will be understood by one of ordinary skill in the art that various changes in form and details may be made therein without departing from the spirit and scope of exemplary embodiments as defined by the following claims. For example, the structure of the memory link architecture, a power-off order, the structure of the shared memory bank of the multi-port semiconductor memory, the structures of the semaphore area and the mail boxes in the internal register, a circuit structure, and an access method may be modified or changed without departing from the scope and spirit of the invention.

In addition, data may be stored in the flash memory by an ASIC processor or other processors. The data path controller that controls the data paths between the shared memory area of the FMC and the port units may be implemented in various ways. In the above-described exemplary embodiments, the internal register includes the semaphore area and the mail boxes, but the invention is not limited thereto. For example, the technical spirit of the invention may be applied to other non-volatile memories such as phase-change random access memories (PRAMs).

What is claimed is:

1. A multi-processor system comprising:
a first processor adapted to writing a power-off check command to a first mail box, reading a power-off wait message or a power-off allowance message written to a second mail box, and waiting or performing a turning off the multi-processor system, in a power-off operation mode;
a second processor adapted to indicating whether data is completely stored during a current processing operation in response to the power-off check command in the first mail box and writing the power-off wait message or the power-off allowance message to the second mail box according to the indication result; and
a multi-port semiconductor memory device having an internal register that includes the first and second mail boxes and dedicated and shared memory areas for data processing, and the dedicated and shared memory areas being accessed by the first and second processors.

2. The multi-processor system of claim 1, wherein the first and second mail boxes serve as latch storage units.

3. The multi-processor system of claim 1, wherein the first processor waits for the power-off allowance message in response to reading the power-off wait message.

4. The multi-processor system of claim 1, further comprising:
a non-volatile semiconductor memory device connected to the second processor for storing data of the first processor through the multi-port semiconductor memory device.

5. The multi-processor system of claim 4, wherein the non-volatile semiconductor memory device, the multi-port semiconductor memory device, and the second processor form a memory link architecture.

6. The multi-processor system of claim 5, wherein the current processing operation is an operation of storing data from the shared memory area to the non-volatile semiconductor memory device.

7. The multi-processor system of claim 5, wherein the current processing operation is an operation of storing meta data from the dedicated memory area to the non-volatile semiconductor memory device.

8. A multi-processor system comprising:
a multi-port semiconductor memory device including dedicated memory areas that are exclusively accessed by corresponding processors of a plurality of processors, a shared memory area that is shared by the plurality of processors, and an internal register that includes first and second mail boxes for communication between the plurality of processors, and a semaphore area for storing authority information about the use of the shared memory area;
a second processor adapted to indicating whether data is completely stored during a current processing operation in response to receiving a power-off check command in the first mail box and writing a power-off wait message or a power-off allowance message to the second mail box according to the indication result; and
a non-volatile semiconductor memory device connected to the second processor for storing data of the second processor, wherein the non-volatile semiconductor memory device, the second processor, and the multi-port semiconductor memory device form a memory link architecture.

9. The multi-processor system of claim 8, further comprising a first processor adapted to writing the power-off check command to the first mail box, reading the power-off wait message or power-off allowance message written to the second mail box by the second processor, turning off the multi-processor system in response to the power-off allowance message, and waiting for power-off allowance message in response to the power-off wait message, in a power-off operation mode, wherein said non-volatile semiconductor memory device is further adapted to storing data of the first processor through the multi-port semiconductor memory device.

10. The multi-processor system of claim 8, wherein the non-volatile semiconductor memory device is a flash memory device.

11. The multi-processor system of claim 8, wherein the first and second mail boxes serve as latch storage units.

12. The multi-processor system of claim 8, wherein the current processing operation is one of storing data from the shared memory area or of storing meta data from the dedicated memory area to the non-volatile semiconductor memory device.

13. The multi-processor system of claim 8, wherein the second processor receives the power-off check command in the first mail box from a first processor.

13. A method of preventing data loss during power-off in a multi-processor system including a plurality of processors that access a shared memory area of a multi-port semiconductor memory device, comprising:
transmitting, by a transmitter-side processor, a power-off check command to a first mail box of the multi-port semiconductor memory device in a power-off operation mode;
transmitting, by a receiver-side processor, a power-off wait message to a second mail box of the multi-port semiconductor memory device when a current processing operation is a data storage operation;
waiting, by the transmitter-side processor, to turn off the multi-processor system in response to receiving the power-off wait message; and
turning off the multi-processor system, by the transmitter-side processor, in response to receiving a power-off allowance message through the second mail box.

14. The method of claim 13, wherein said receiver-side processor reads said power-off check command from said first mail box.

15. The method of claim 13, wherein the data storage operation comprises:
transmitting, by the transmitter-side processor, a cache flush command to said first mail box in a normal operation mode;
reading, by the receiver-side processor, said cache flush command from said first mail box;
transmitting, by said receiver side processor, an indicator to said second mailbox, said indicator indicative of whether said cache flush has completed or not; and
receiving, by the transmitter-side processor, said indicator, wherein if said indicator indicates that said cache flush is not completed, said transmitter-side processor waits until said indicator indicates that the cache flush is completed.
